(19) United States
(12) Patent Application Publication
(10) Pub. No.: US 2024/0416585 A1
(43) Pub. Date: Dec. 19, 2024

(54) 3D PRINTER AND RELATED SET OF PARTS

(71) Applicant: Joseph ISSA, Montreal (CA)

(72) Inventor: Joseph ISSA, Montreal (CA)

(21) Appl. No.: 18/699,498

(22) PCT Filed: Oct. 14, 2022
(86) PCT No.: PCT/CA2022/051522

§ 371 Date: Apr. 8, 2024

Related U.S. Application Data
(60) Provisional application No. 63/256,517, filed on Oct. 15, 2021.

(51) Int. Cl. B29C 64/25; B29C 64/232; B29C 64/236; B33Y 30/00

(52) U.S. Cl. CPC B29C 64/25; B29C 64/232; B29C 64/236; B33Y 30/00

(57) ABSTRACT

A set of parts for assembling a 3D printer and a 3D printer. The set of parts includes one or more modular constructions sets comprising a plurality of interconnectable blocks for assembling structural elements of the 3D printer. A specimen holder component's structural elements are configured to be assembled from the plurality of interconnectable blocks. The set of parts includes a z-axis component for moving the specimen holder component along a z-axis therealong thereby determining a z-axis coordinate of the definite 3D location when the set of parts is assembled into the 3D printer. A z-axis component's structural elements are configured to be assembled from the plurality of interconnectable blocks.

### PRIORITY STATEMENT UNDER 35 U.S.C § 0.119 (E) & 37 C.F.R. § 0.1.78

This non-provisional patent application claims priority based upon the prior U.S provisional patent application entitled “3D PRINTER, RELATED SET OF PARTS AND METHODS”, application No. 63/256,517, filed 2021 Oct. 15, in the name of Joseph Issa, which is hereby included herein by reference in its entirety.

### TECHNICAL FIELD

The present invention relates to a 3D printer and related set of parts.

### BACKGROUND

Existing conventional 3D printers are specialized pieces of equipment that are making their way into the mainstream market. It is currently possible to buy parts to build your own 3D machine, which requires time and knowledge. On the other hand, one can also buy an assembled 3D machine that is ready to use. In both cases, in order to build and assemble the 3D machine, multiple mechanical parts have to be sourced from multiple companies, which increase the cost, complexity and time of the assembled 3D machine. Furthermore, the available options of 3D printer kits are targeting a knowledgeable audience with pre-existing understanding of 3D printing.

The present invention at least partly addresses this shortcoming.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect relates to a set of parts for assembling a three-dimensional (3D) printer for 3D printing a specimen therewithin. The set of parts includes one or more modular constructions sets comprising a plurality of interconnectable blocks for assembling structural elements of a 3D printer. The set of parts also includes a hot end holder component for holding the hot end holder at the definite 3D location within the 3D printer when the set of parts is assembled into the 3D printer. The set of parts also further includes a specimen holder component for receiving the specimen within the 3D printer, the specimen holder component having a y-axis rack and pinion mechanism for moving a sliding plate component along a y-axis thereby determining a y-axis coordinate of the definite 3D location. A y-axis rack section of the y-axis rack and pinion mechanism is provided in a single material. The specimen holder component's structural elements are configured to be assembled from the plurality of interconnectable blocks. The set of parts also includes an x-axis component having an x-axis rack and pinion mechanism for moving the hot end holder component along an x-axis therealong over the specimen holder component thereby determining an x-axis coordinate of the definite 3D location. An x-axis rack section of the x-axis rack and pinion mechanism is provided in the single material. The set of parts includes a z-axis component for moving the specimen holder component along a z-axis therealong thereby determining a z-axis coordinate of the definite 3D location when the set of parts is assembled into the 3D printer. An x-axis pinion section of the x-axis rack and pinion mechanism and a y-axis pinion section of the y-axis rack and pinion mechanism are provided in the single material. A z-axis pinion section of the z-axis rack and pinion mechanism is provided in the single material thereby providing the rack and pinions mechanisms along the x-axis, the y-axis and the z-axis in the single material. The z-axis component's structural elements are configured to be assembled from the plurality of interconnectable blocks.

Optional elements of the first aspect may also include one or more of the following features. The set of parts may include: the controller; an x-axis motor to be assembled in direct connection with the x-axis pinion section of the x-axis rack and pinion mechanism for moving the hot end component along the x-axis within the 3D printer; and a y-axis motor to be assembled in direct connection with the y-axis pinion section of the y-axis rack and pinion mechanism for moving the specimen holder component along the y-axis within the 3D printer. The set of parts may also, alternatively or additionally, include: an x-axis limit-switch for the x-axis component; a y-axis limit-switch for the specimen holder component; and a z-axis limit-switch for the z-axis component, the x-axis limit-switch, the y-axis limit-switch and the z-axis limit-switch being for calibrating the definite 3D location within the 3D printer when the 3D printer assembled from the set of parts is in use. Additionally or alternatively, the sliding plate component's structural elements may be configured to be assembled from the plurality of interconnectable blocks. Likewise, additionally or alternatively, the plurality of interconnectable blocks may be limited to usual interconnectable blocks.

A second aspect of the present invention relates to a 3D printer comprising a hot end, a controller, a support structure, a hot end holder, a specimen holder and a z-axis motor assembly. The controller sets a definite 3D location of the hot end in relation to the specimen; and controls the hot end for selectively extruding material to 3D-print the specimen. The support structure provides a first groove defining a first plane along a z-axis within the 3D printer. The support structure is assembled from one or more modular construction sets having a plurality interconnectable blocks. The hot end holder moves the hot end along an x-axis within the 3D printer in accordance with instructions received from the controller, thereby determining an x-axis coordinate of the definite 3D location. The specimen holder component is assembled from the plurality of interconnectable blocks and is maintained in the first groove of the enclosure. The specimen holder has a receiving surface defining a second plane along a y-axis within the 3D printer, the first plane and the second plane being perpendicular. A sliding plate over which the specimen is 3D-printed by the hot end is positioned on the receiving surface. A y-axis motor assembly causes the sliding plate to slide in on the receiving surface in accordance with instructions received from the controller, thereby determining a y-axis coordinate of the definite 3D location. The z-axis motor assembly the comprising the z-axis motor causes the specimen holder component to slide in the first groove along the first plane in accordance with instructions received from the controller, thereby determining a z-axis coordinate of the definite 3D location.

Optionally, the second aspect may also include one or more of the following features. The sliding plate may be assembled from the plurality of interconnectable blocks. The 3D printer may optionally, additionally or alternatively, include: an x-axis limit-switch for the hot end holder; a y-axis limit-switch for the specimen holder component; and a z-axis limit-switch for the z-axis component, the x-axis limit-switch, the y-axis limit-switch and the z-axis limit-switch being for calibrating the definite 3D location within the 3D printer. The 3D printer may also include, additionally or alternatively, an adjustment tab parallel to the first plane to impede non-z-axis-movements of the specimen holder component in the first groove. The plurality of interconnectable blocks may be limited, additionally or alternatively, to usual interconnectable blocks.

### BRIEF DESCRIPTION OF THE DRAWINGS

Further features and exemplary advantages of the present invention will become apparent from the following detailed description, taken in conjunction with the appended drawings, in which:

FIGS. 1, 2 and 3 are a perspective views of an exemplary set of parts provided in a single material combined with a plurality of interconnectable blocks for providing a three-dimensional (3D) printer in accordance with the teachings of the present invention;

FIG. 4 is a side view of the set of parts;

FIG. 5 is an exploded perspective view of an alternate set of parts;

FIGS. 6A1, 6A2, 6A3, 6B1, 6B2, 6B3 and 6B4 herein referred to concurrently as FIG. 6 are perspective views of an x-axis component in accordance with the teachings of the present invention;

FIGS. 7A, 7B, 7C, 7D, 7E, 7F herein referred to concurrently as FIG. 7 are perspective views of a heat shield in accordance with the teachings of the present invention;

FIGS. 8A and 8B, together referred to as FIG. 8, are perspective views of an exemplary x-axis motor and extruder motor support component in accordance with the teachings of the present invention;

FIGS. 9A and 9B, together referred to as FIG. 9, are perspective views of an exemplary single material z-axis rack component in accordance with the teachings of the present invention;

FIGS. 10A and 10B, together referred to as FIG. 10, are perspective views of an exemplary main z-axis limiter component in accordance with the teachings of the present invention;

FIGS. 11A and 11B, together referred to as FIG. 11, are perspective views of an exemplary pinion component in accordance with the teachings of the present invention;

FIG. 12 is a perspective view of an exemplary pinion component in accordance with the teachings of the present invention.

FIGS. 13A and 13B, together referred to as FIG. 13, are perspective views of an exemplary y-axis motor support component in accordance with the teachings of the present invention;

FIGS. 14A and 14B, together referred to as FIG. 14, are perspective views of an exemplary z-axis motor support component in accordance with the teachings of the present invention;

FIGS. 15A and 15B, together referred to as FIG. 15, are perspective views of an exemplary sliding plate component in accordance with the teachings of the present invention;

FIGS. 16A and 16B, together referred to as FIG. 16, are perspective views of an exemplary y-axis limiter component in accordance with the teachings of the present invention;

FIGS. 17A and 17B, together referred to as FIG. 17, are perspective views of an exemplary x-axis limiter component in accordance with the teachings of the present invention;

FIGS. 18A and 18B, together referred to as FIG. 18, are perspective views of an exemplary complementary z-axis limiter component in accordance with the teachings of the present invention;

FIG. 19 is a perspective view of an exemplary limit-switch compatible with a 3D printer in accordance with the teachings of the present invention;

FIG. 20 is a perspective view of an exemplary fan compatible with a 3D printer in accordance with the teachings of the present invention;

FIG. 21 is a perspective view of an exemplary extruder/hot end assembly compatible with a 3D printer in accordance with the teachings of the present invention;

FIG. 22 is a perspective view of an exemplary adjustment tab in accordance with the teachings of the present invention; and

FIG. 23 is a perspective view of an exemplary electric motor compatible with a 3D printer in accordance with the teachings of the present invention.

### DETAILED DESCRIPTION

One exemplary advantage provided by some embodiments described herein is allowing tool-free assembly of a 3D printer. Additional advantages may include the provision of a plurality of safety mechanisms to help in preventing harmful operation of the 3D printer.

Embodiments of the present invention are directed to a set of parts, or a kit comprising one or more sets of parts for building a three-dimensional (3D) printer (or an additive manufacturing device). In one embodiment, structural parts of the 3D printer are provided as a modular construction set (e.g., set of interconnectable blocks) and all inter-moving parts are designed to be 3D printed by a manufacturing device (not shown) to be compatible and/or complementary to the modular construction set (except, e.g., the specimen receiving plate). Skilled persons will have recognized that the inter-moving parts do not comprise motors or fans, but rather refer to the portions of the 3D-printer that move relative to one another. More specifically, as can be readily appreciated, electrical, electronic, motor, extruding systems and hot ends are in non-3D printed material. The specimen receiving plate is made of a material that resists and does not melt or does not otherwise permanently adhere to the specimen being extruded. The temperature-resistant material of the specimen receiving plate could, for instance, be glass or acrylic glass.

For instance, inter-moving parts of the 3D printer except the specimen receiving plate may be made of a single material with regards to physical properties such as phase reversibility characteristics. The single material may represent variations of slightly different compositions presenting the same or sufficiently close physical properties to be used in a given manufacturing device, as will be readily apparent to skilled persons (e.g., characteristics that fit the requirements of a manufacturing 3D printer, of a laser cutter machine and/or of a molding apparatus, etc.). For instance, the single material may be provided in different colors. It should be appreciated that having all moving parts of the 3D printer except the specimen receiving plate made of the single material necessitates that movement controlling mechanisms along the three (3) axes be made of the single material. The technical solution to the challenge presented by this exemplary set of embodiments is to use three rack and pinion mechanisms along the three axes of movement, which in turn requires that two of the three rack and pinion mechanisms be provided on inter-moving parts at 90° from one another. The unintuitive three rack and pinion mechanisms solution is necessary as the usual threaded-rod mechanism along the z-axis and timing belt and pulley mechanisms along the x axis and y axis comprise parts that cannot be provided in the single material. The moving parts of the 3D printer may further be partly or completely molded or otherwise manufactured in the single material (e.g., using laser-cutting equipment).

Alternatively or in addition, structural parts of the 3D printer may be provided as a modular construction set (e.g., set of interconnectable blocks) and most moving parts of the 3D printer are designed to be 3D printed by a manufacturing device (not shown) except the specimen receiving plate and one or more pinions of rack and pinions mechanisms may further be provided in more durable material (e.g., metal) and/or the z-axis movement may be provided using non-3D printed threaded rods and associated conventional hardware. In all the different embodiments, in order to be functional once assembled, the parts of the 3D printer need to allow positioning of a hot end at a definite 3D location therewithin, with sufficient precision, considering the expected use-case of the 3D printer.

Alternatively or in addition, most structural parts and most moving parts of the 3D printer may be designed to be 3D printed by a manufacturing device (not shown) and a complementary set of parts are pre-cut or pre-manufactured, e.g., using laser cutting apparatus and/or molding apparatus. The parts to be 3D printed by a manufacturing device are designed for the single material as discussed above. However, the complementary set of parts may comprise parts of different material and/or of material selected based on manufacturing technique. For instance, laser cutting is more efficient for manufacturing of small number of flat, thin wood parts while molding is more efficient for larger scale production of relatively large parts. Skilled persons will readily understand how to adapt the teachings of the present invention to such mixed-material configurations.

In all the different embodiments, in order to be functional once assembled, the parts of the 3D printer need to allow positioning of a hot end at a definite 3D location therewithin, with sufficient precision, considering the expected use-case of the 3D printer.

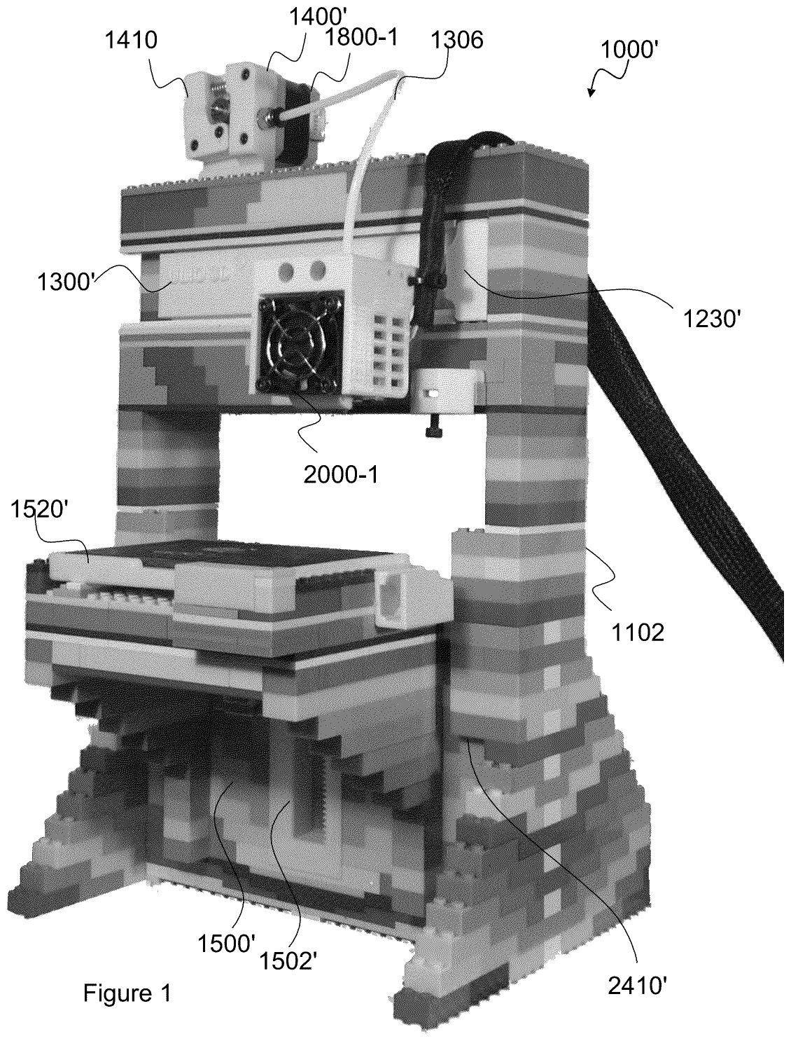

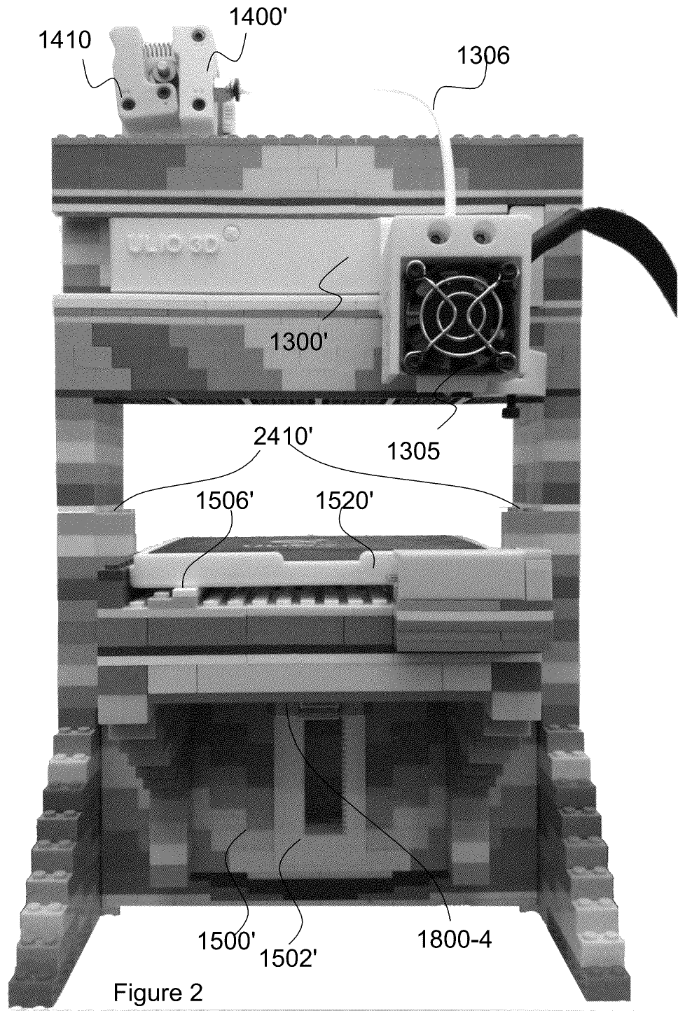

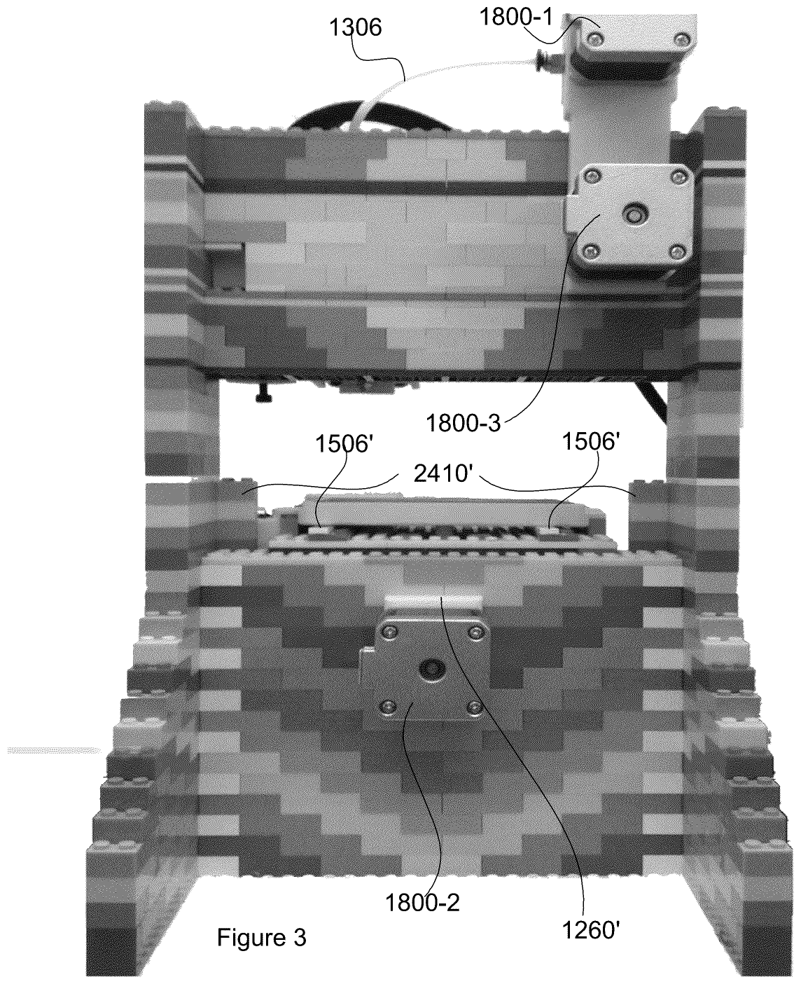

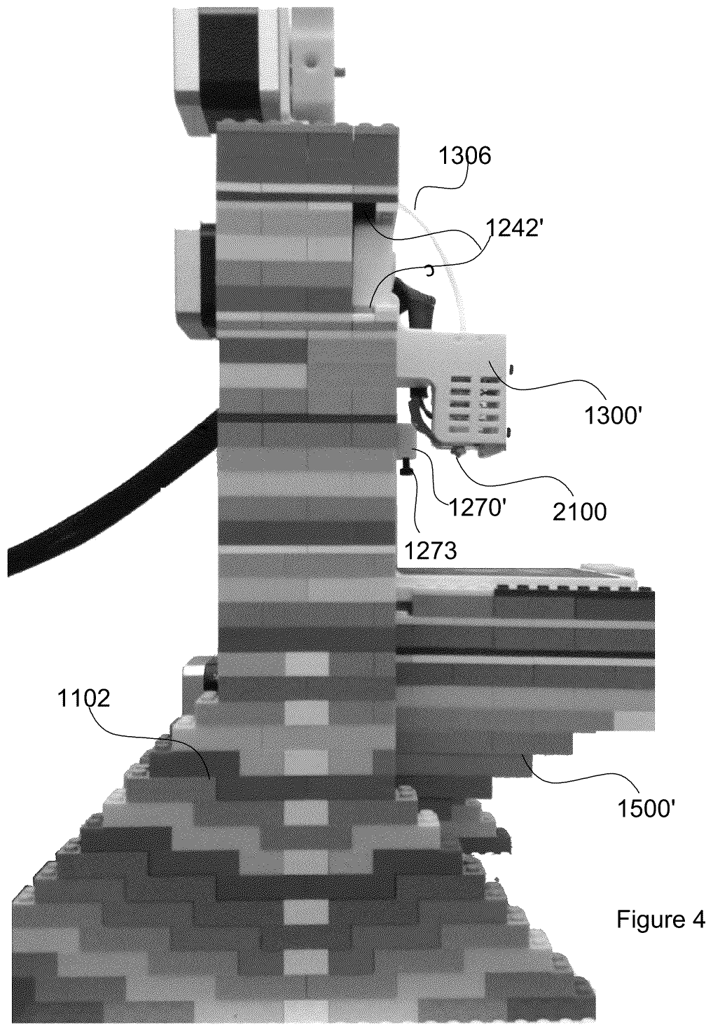

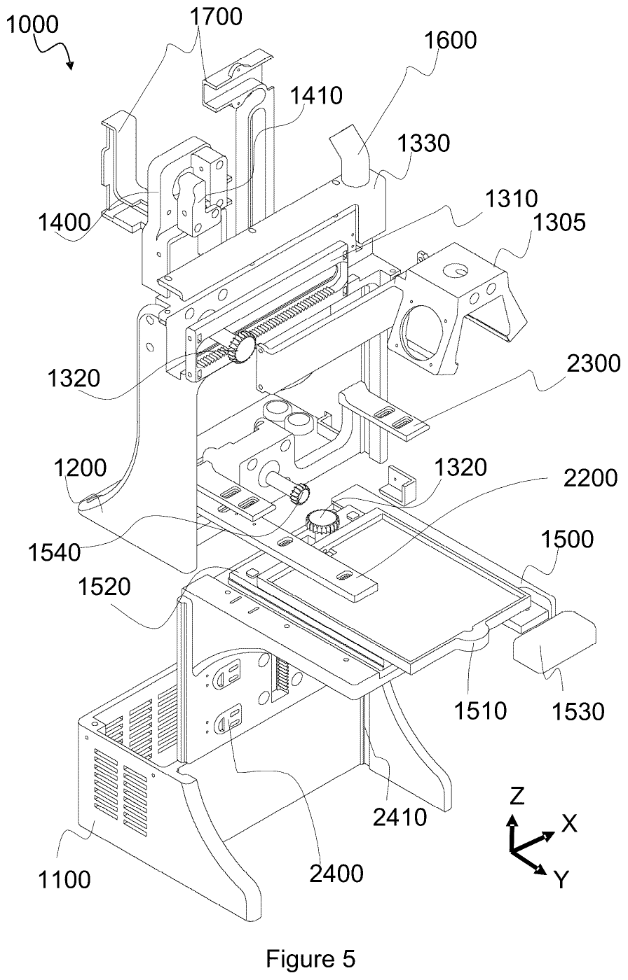

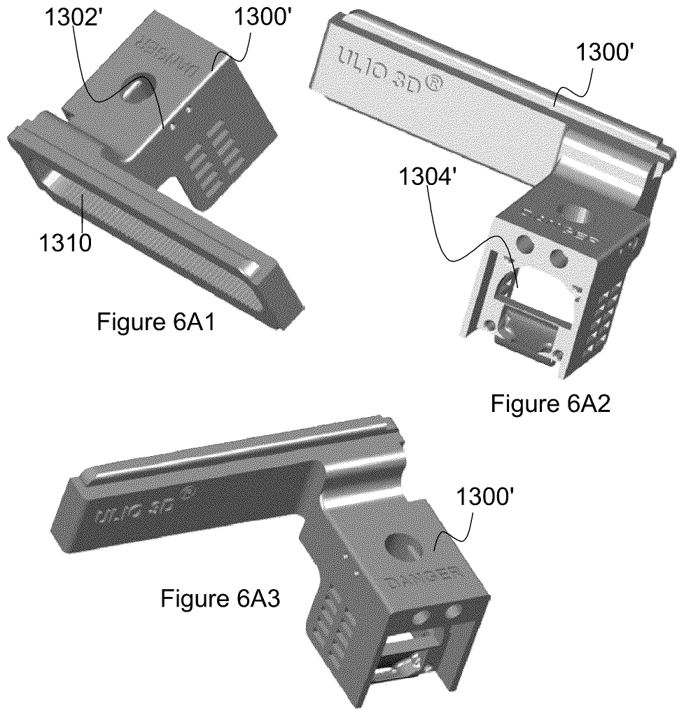

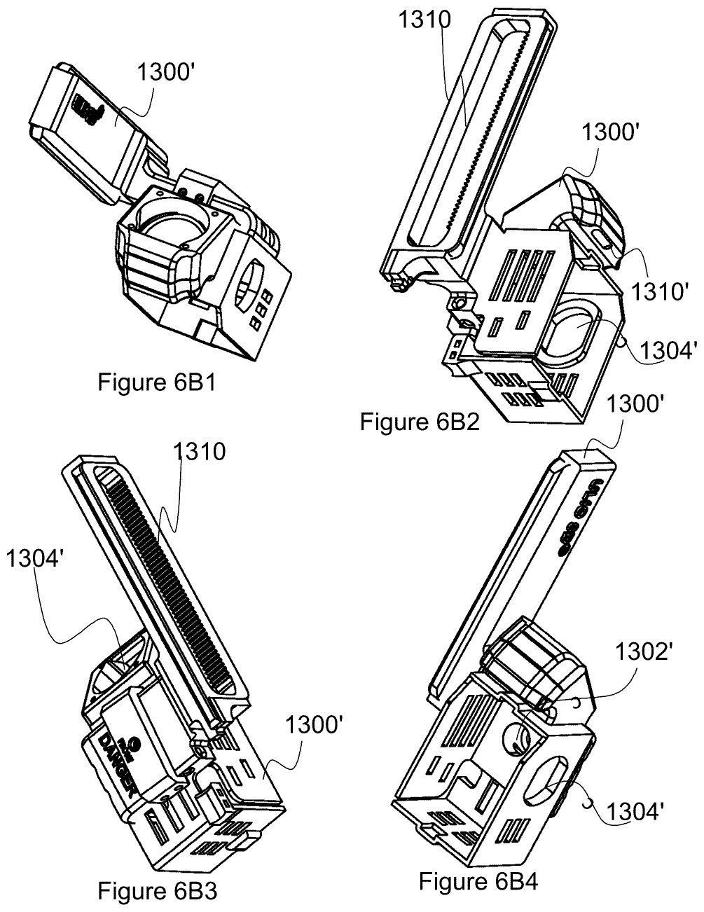

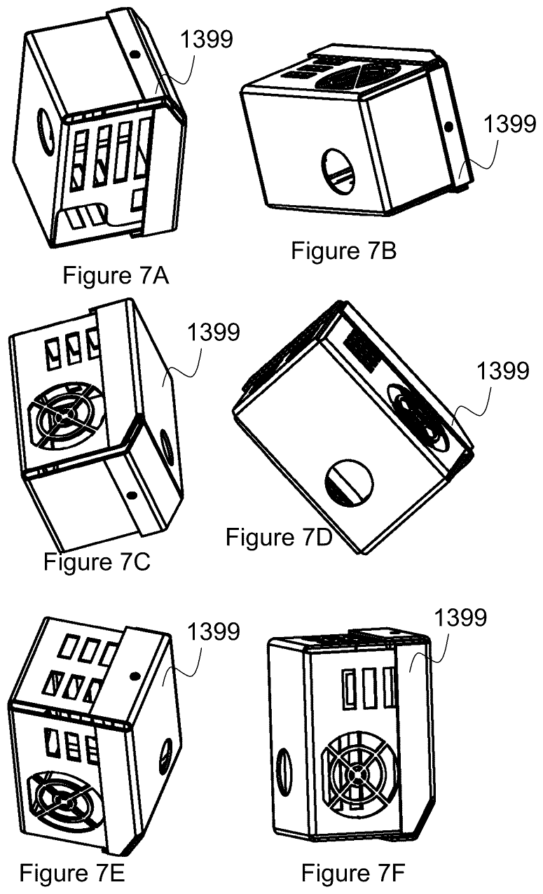

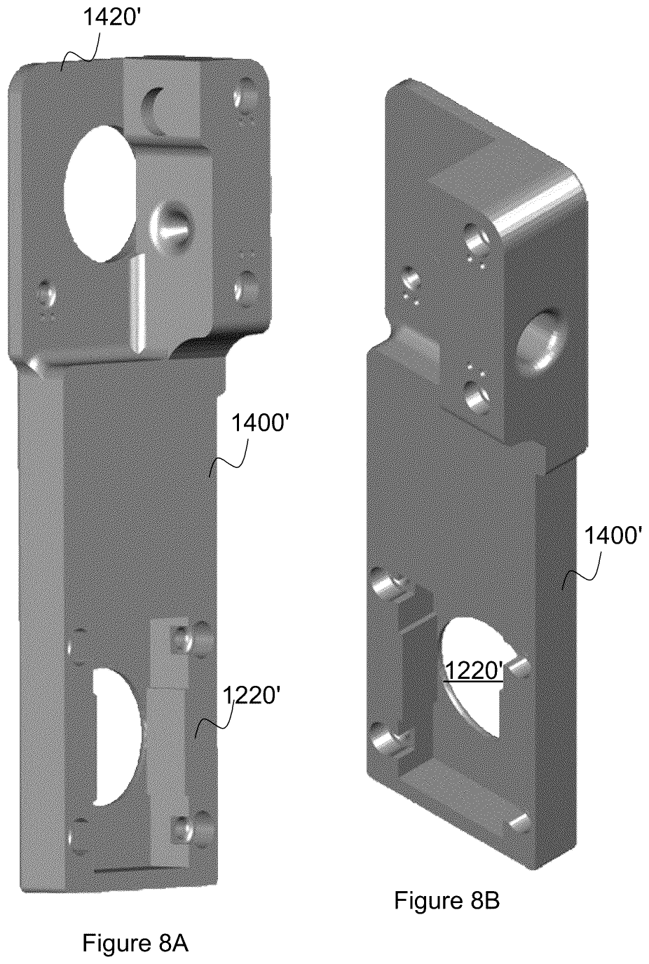

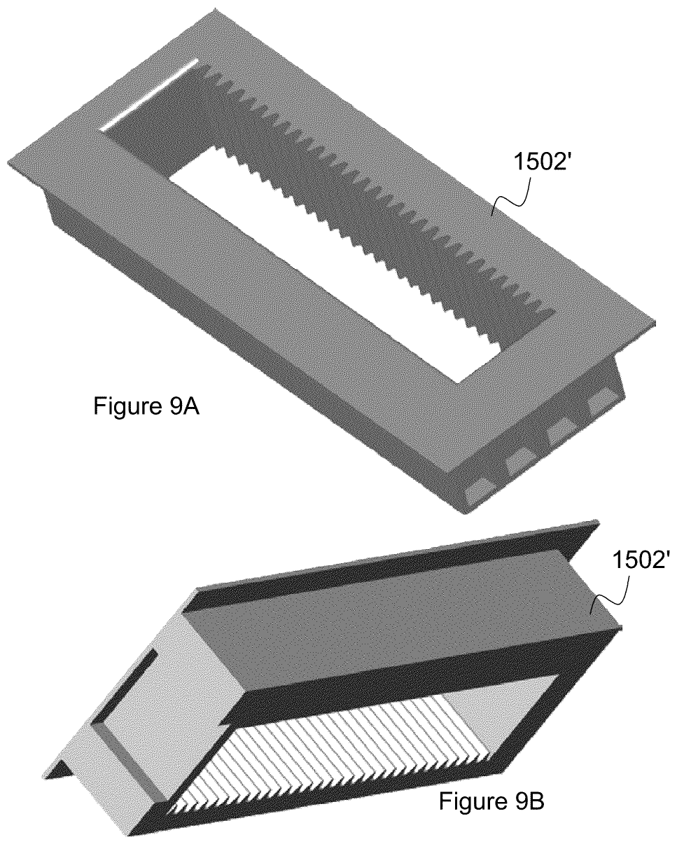

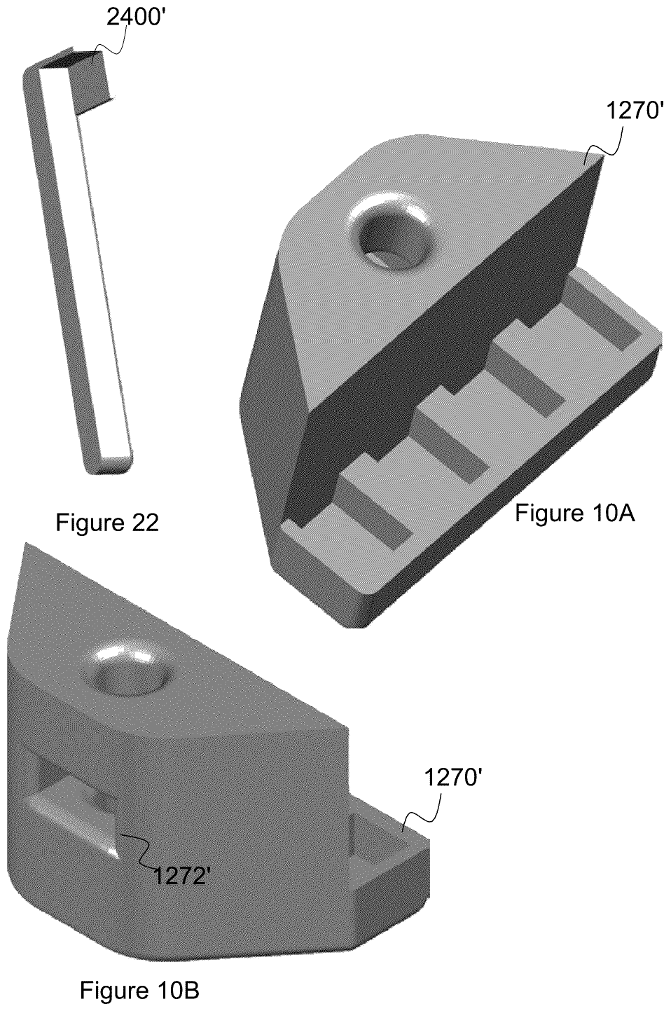

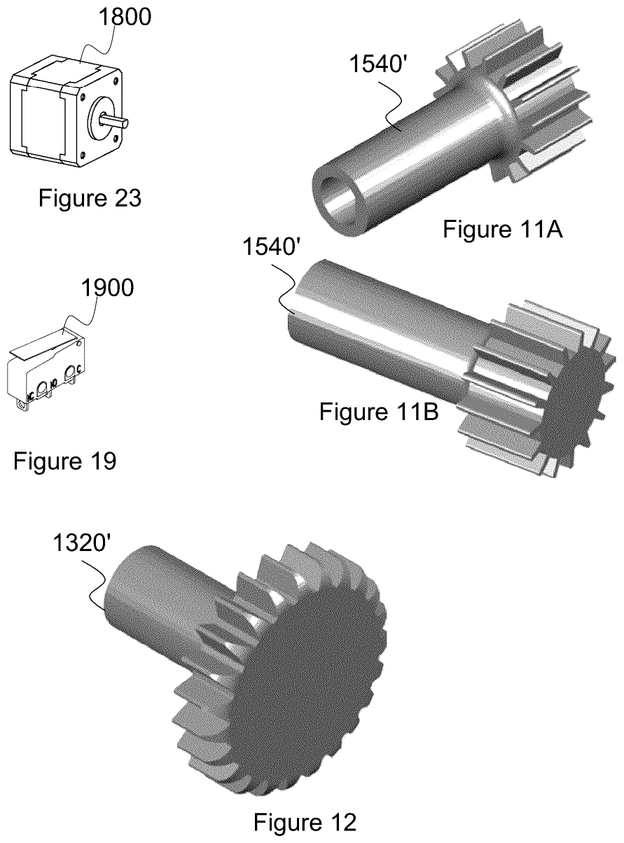

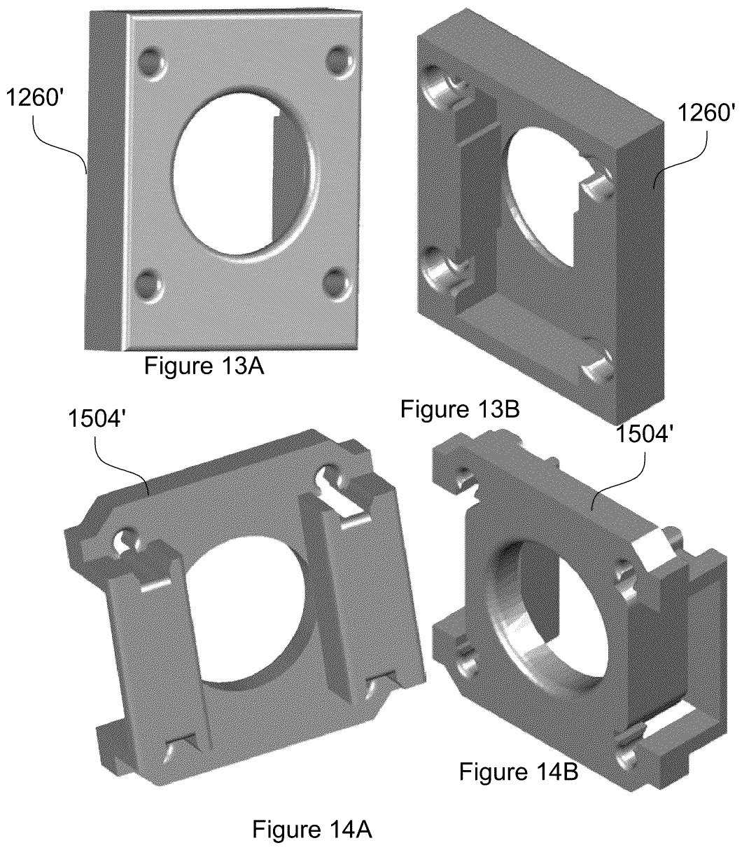

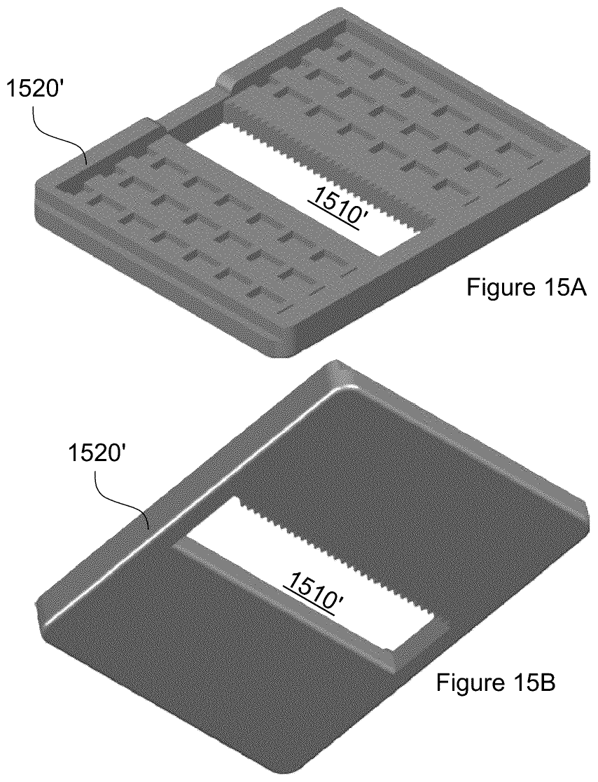

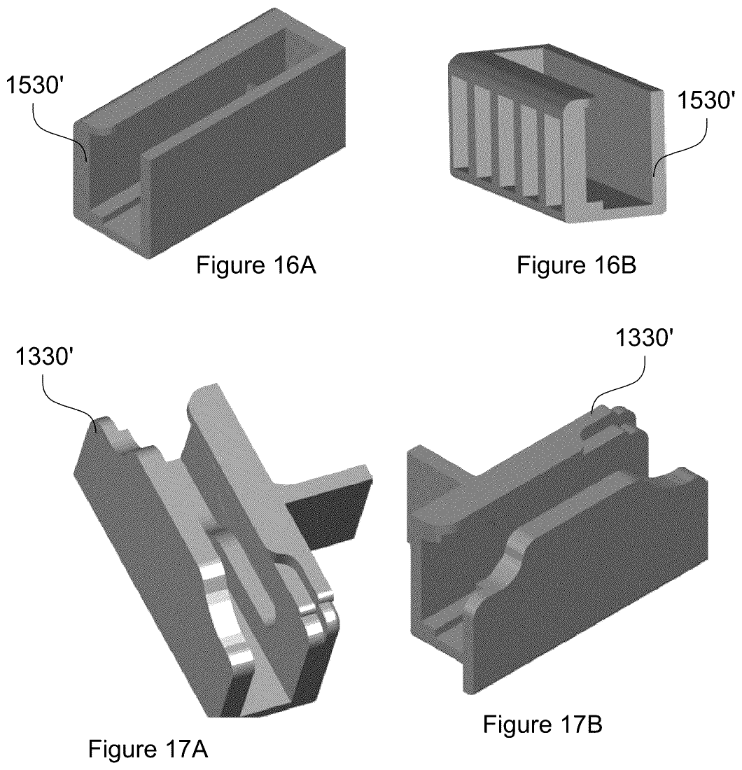

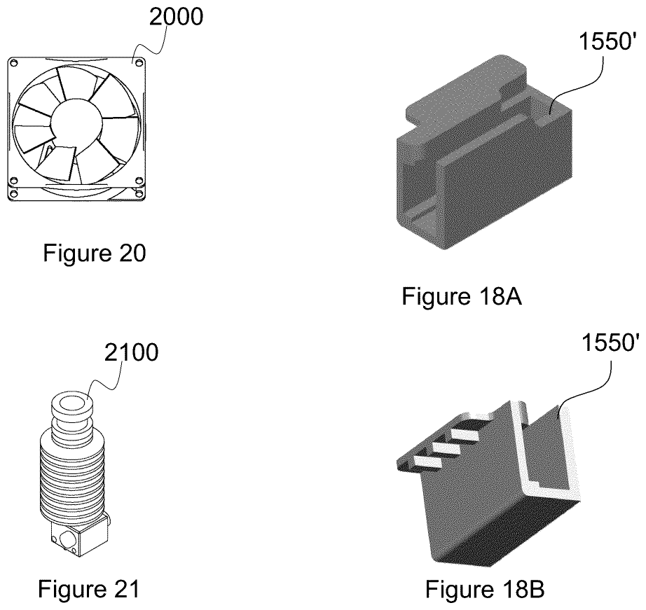

Reference is now made to the drawings in which FIGS. 1, 2 and 3, which show perspective views and FIG. 4 showing a side view of an exemplary first set of parts 1000′ provided at least partially in a single material and at least partially in a construction set comprising a plurality of interconnectable blocks for assembling a three-dimensional (3D) printer in accordance with the teachings of the present invention. In order to be functional, the first set of parts 1000′ once assembled need to provide a structure that can position a hot end at a definite 3D location within a 3D printer, with sufficient precision. For greater certainty, a z-axis is defined in the following description along the height of the depicted example of FIG. 1, an x-axis is defined along the width of the depicted example of FIG. 1 and a y-axis is defined along the depth of the depicted example of FIG. 1. Reference is also concurrently made, in addition to FIGS. 6 to 23, which each shows at least one part from the exemplary first set of parts 1000′. FIG. 4 provides an exploded view of an alternate set of parts.

The single material may be a thermoplastic. Skilled persons will recognize that the reference to “single material” does not refer to the color or other aesthetical characteristics, but to technical specifications of the single material. The “term thermoplastics” applies to polymers that reversibly change phase with temperature. While keeping within a boundary of temperatures, these phase changes can be done safely and the material returns to its original solid state after cooling, without any significant alteration in its original properties. Advantageously, PLA (polylactic acid) thermoplastic may be used as the single material. Different kinds of thermoplastic may also be used and still be considered a single material. Skilled persons will recognize that other types of thermoplastics (PHA, ABS, HDPE, etc.) may also be used depending on the technology used to manufacture the set of parts 1000′. Furthermore, skilled persons will recognize that other material than thermoplastic that would exhibit temperature-based phase reversibility or other phase reversibility properties may also be used in other embodiments provided that such material can be extruded or otherwise selectively positioned using a hot end or other distribution mechanism having similar properties (e.g., that is adapted in terms of size and other usability characteristics for domestically-used manufacturing device).

The plurality of interconnectable blocks of the construction set may be made of the same “single material” or a different material, which may also be a thermoplastic. For instance, it is frequent to use ABS to manufacture interconnectable blocks.

The single material may be for all depth-affected components while flat structural elements may be provided in one or more other materials (e.g., wood). Skilled person will readily acknowledge that parts from different materials and/or manufactured by different apparatuses and/or techniques may be provided together (e.g., laser-cut parts and molded parts).

In one embodiment a main structure 1102 of the 3D printer is assembled from a construction set comprising a plurality of interconnectable blocks.

Electrical components are not necessarily shown on the example of FIG. 1 (such as a power switch, a USB port, a memory card reader and/or a microcontroller card, etc.) An AC and/or DC power input port is also expected. For instance, a transformer (e.g., 120 VAC to 24, 12 and/or 5 VDC) may be expected to be housed within a separate enclosure and/or one or more VDC input may also be provided. Typically, only one VDC input is expected to be provided. However, as skilled people will recognize, the microcontroller or another of the hosted electrical components may be programmed to select the most appropriate of the power input(s) when more than one is received. While it is not expected to be the most viable source of power considering the typical time taken by a 3D printer to complete a task, batteries or other portable power devices could also be used as a main source or as a temporary backup source of power (e.g., to avoid cancelling a job in progress). The electrical components are not made of the same material as the set of parts 1000′. Yet, electrical components are necessary for the 3D printer to be built from the set of parts 1000′, to receive power and to obtain a 3D model corresponding to a specimen to be manufactured by the 3D printer (e.g., read from a memory card and/or received from a computer, e.g., via a USB interface, a parallel interface, a network interface (e.g., Ethernet connection over wired or wireless medium), etc.).

The main structure 1102 holds an x-axis component 1300′ of the set of parts 1000′ in place when the set of parts 1000′ is assembled into the 3D printer. A motor socket 1220′ is provided for receiving an x-axis motor 1800-3 for driving a pinion 1320′ in a rack 1310′ and pinion 1320′ assembly for the x-axis component 1300′ of the 3D printer. A limit-switch opening 1230′ may be provided on the one side of the main structure 1102 (depicted on the right side) for allowing maximum movement length of the x-axis component 1300′ along the x-axis. Skilled persons will readily understand that other manners of assembling/designing the main structure 1102 (e.g., the shape/length of the supporting legs, etc.) may be used without affecting the teachings of the invention.

The rack 1310′ of the x-axis component 1300′ is maintained against the main structure 1102 in a groove 1242′ formed in the main structure 1102 for allowing the rack 1310′ to move therealong when the pinion 1320′ rotates. A hot end holder of the x-axis component is fixed on the rack 1310′ thereby determining an x-axis coordinate of the definite 3D location as a function of the rotation of the pinion 1320′ and the position of the limit-switch opening 1230′ when the set of parts 1000′ is assembled.

In the depicted example, x-axis component 1300′ comprises a hot end socket 1302′ for receiving a hot end 2100 and one or more openings 1304′ for receiving corresponding fans 2000-1 for controllably (e.g., continuously or selectively) cooling material extruded therefrom. Skilled persons will readily understand that other manners of assembling/designing x-axis component 1300′ (e.g., the shape/length/position of the opening(s) 1304′, radius/gear depth of the pinion 1320′, etc.) may be used without affecting the teachings of the invention. The x-axis component 1300′ comprises, in the embodiment depicted in FIG. 6B, a fan outlet 1310′ that is shaped to focus an airflow towards a tip of the hot end 2100, which is also in close proximity to the specimen when printing. The fan outlet 1310′ also causes the airflow to cool a downward surface of a correspondingly shaped metal casing 1399. The metal casing 1399 participates to safety of the 3D printer by limiting access to the hot end 2100 in use. In addition of alternatively to the kit of parts 1100′ comprising metal casing 1399, additional safety mechanisms may be provided to limit movement on the x-axis and/or y-axis to ensure that the hot end 2100 remains over the sliding plate 1520′ at all times. Additionally or alternatively, a thermistor (not visible) may be provided within the metal casing 1399 to cut-off electrical connection to the hot end 2100 in case of temperature runoff. The controller of the 3D printer itself may, additionally or alternatively, also comprise additional software features to avoid excessive temperatures of the hot end 2100.

In the depicted example, the main structure 1102 also provides a filament extrusion mechanism 1400′ for feeding a raw material filament at a measured pace towards the hot end 2100. A motor socket 1420′ is provided for allowing a feed motor 1800-1 to frictionally engage the raw material filament (e.g., using a drive gear and a bearing). A lever 1410 fixed to the filament extrusion mechanism 1400′ allows to maintain the raw filament wire against the motor 1800-1 using a biasing means (such as a spring). When the feed motor 1800-1 controllably rotates in the assembled 3D printer in use, the raw material filament advances at a controlled pace towards the hot end 2100. The filament is routed from the filament extrusion mechanism 1400′ to the hot end 2100 within a tube 1306. Skilled persons will readily understand that other manners of assembling/designing the filament extrusion mechanism 1400′ may be used without affecting the teachings of the invention.

A z-axis component of the set of parts 1000′ moves a specimen holder component 1500′ along the z-axis, thereby determining a z-axis coordinate of the definite 3D location. In the depicted example, the main structure 1102 provides a motor socket 1260′ for receiving a z-axis motor 1800-2 for driving a pinion 1540′ in a rack 1502′ and pinion 1540′ assembly of the z-axis component of the 3D printer when assembled. In the depicted example, side portions of the specimen holder component 1500′ slides along the main structure 1102 in a groove 2410′ provided therealong. Optional adjustment tab 2400′ may be provided to limit potential rotation of the specimen holder component 1500′ along the y axis and/or limit potential movements of the specimen holder component 1500′ along the x-axis. The adjustments tab 2400′ may be useful to compensate and better adapt to slight differences between the different parts. As can be appreciated, the specimen holder component 1500′ partly integrates the z-axis component as it comprises the rack 1502′ of the z-axis component. The rack 1502′ would typically be provided as a distinct part made of the single material in the set of parts 1000′ (e.g., similar to the rack 1310′) positioned and positioned in the specimen holder 1500′ during assembly. Structural elements of the z-axis component are provided by vertical portions of the specimen holder component 1500′ maintained along the main structure 1102 in the groove 2410′.

In the depicted example, set of parts 1000′ also comprises a part 1270′ made of the single material having a screw hole and nut slot 1272′ for receiving a z-axis limiter 1273 for engaging a corresponding z-axis limit-switch of the set of parts 1000 from the specimen holder component 1500 when assembled.

A y-axis component moves a sliding plate 1520′, on the specimen holder component 1500′, along the y-axis, thereby determining a y-axis coordinate of the definite 3D location. The specimen holder component 1500′ comprises a motor socket 1504′ for receiving ay-axis motor 1800-4 for driving a pinion (similar to 1320′, e.g., which may be provided in duplicate on the set of parts 1000′) in a rack 1522′ and pinion 1320′ assembly of the y-axis component of the 3D printer. The rack 1522′ is part of the sliding plate 1520′ positioned on the specimen holder component 1500′ on a receiving surface 1506′ over side portions 1526 and 1528 of the sliding plate 1520.

As can be appreciated, when three rack and pinion mechanisms (1310′, 1320′; 1502′, 1540′ and 1522′, 1320′) are provided as depicted, two of the three (1502′, 1540′ and 1522′, 1320′) are provided on inter-moving components. Said differently, all parts of one of the three rack and pinion mechanisms move together along an axis controlled by another one of the three rack and pinion mechanisms. With particular reference to the depicted example, when assembled, the specimen holder component 1500′ moves relative to the main structure 1102 along the z-axis and the x-axis component 1300′ moves relative to the main structure 1102 along the x-axis. In order to control the definite 3D location when the 3D printer is assembled from the set of parts 1000′, the y-axis component moves along the y-axis, but also moves altogether with the specimen holder component 1500′ along the z-axis. Structural elements of the y-axis component are provided by horizontal portions of the specimen holder component 1500′ comprising the sliding plate 1520′ maintained horizontally along the specimen holder component 1500′.

FIG. 19 shows an exemplary limit-switch 1900 compatible with a set of parts for assembling a 3D printer in accordance with the teachings of the present invention. In the preferred embodiment, three units of the limit-switch 1900 are used, or provided together, with the set of parts 1000′ for all limit-switch purposes of the 3D printer when assembled and in use. Calibration of the three axes may be performed by using the limit-switches 1900, thereby ensuring that tolerancing of the different parts is correctly considered. For instance, the limit-switch Microswitch/SS-3GL13PT may be used. Other calibration means and methods may be used, as skilled persons will acknowledge, without affecting the teachings of the invention.

FIG. 20 shows an exemplary fan 2000 compatible with a set of parts for assembling a 3D printer in accordance with the teachings of the present invention. In the preferred embodiment, a single unit of the fan 2000 is used, or provided together, with the set of parts 1000′ for all ventilation purposes of the 3D printer when assembled and in use. For instance, two 40 mm fans XJ12B6020H laterally and one 30 mm XYJ24B3010H may be used facing the hot end. Other cooling configurations may of course be used, as skilled persons will acknowledge, without affecting the teachings of the invention.

FIG. 21 shows an exemplary hot end 2100, without the thermistor, the Bowden add-on and the heated bloc 2100, compatible with a 3D printer in accordance with the teachings of the present invention.

FIG. 23 shows an exemplary motor 1800 compatible with a set of parts 1000′ for assembling a 3D printer in accordance with the teachings of the present invention. In the preferred embodiment, four units of the motor 1800 may be used, or provided together, with the set of parts 1000′ for all motorized purposes of the 3D printer when assembled and in use. For instance, the stepper motor Kysan 1124090/Nema 17 may be used. Motors of different types and/or different motorization means may be used, as skilled persons will acknowledge, without affecting the teachings of the invention by performing customary modifications to the location of motor sockets 1220′, 1260′, 1504′. In some embodiments, the location of motor sockets 1220′, 1260′, 1504′ is selected considering the effect of the motor on the center of gravity of the 3D printer when assembled and, for instance, may be selected so that the overall effect of all the mounted motors when assembled is close to the center of gravity (e.g., counter-balancing each other), which provides for improved balance of the assembled 3D printer.

Skilled persons will readily understand that the design of some or all of the first set of parts 1000′ may be modified to accommodate various types of motors 1800, switches 1900, fans 2000 and/or hot ends 2100 without affecting the teachings of invention.

The use of the rack and pinion solutions for at least the x-axis and y-axis and optionally the z-axis has different exemplary advantages. For instance, the rack and pinion solution avoids the need for a transmission (strap, pulleys, belts, threaded rods, ball bearings, or else), which limits the number of moving parts and also ensures that tolerancing stackup, which may occur when different interacting parts are involved in the transmission.

In optional embodiments, a complete rack and pinion mechanism may be designed to be 3D printable in a single part with a breakable point of attachment. For instance, the pinion may be initially positioned within a dead range of the rack with a breakable point of attachment. A cover may also be printed over the rack and pinion, thereby further limiting the risk of tolerance stackup. However, diagnosis and eventual repair of a broken rack and/or pinion may be made more difficult.

A uniform gear depth (e.g., 0.22″ (about 5.6 mm) in the depicted example) may be selected considering the tolerancing of the 3D printer that may be used for manufacturing the set of parts 1000′.

A filament spool (not shown) may be added onto the main structure 1102, or another non-moving part of the set of parts 1000 for convenience.

Skilled persons will recognized that the exemplary design depicted and described herein can be stretched up to provide a larger 3D printer or stretched down to provide a smaller 3D printer. Skilled persons will readily recognize the stretching limits by considering the material thickness and resistance and/or by routine testing.

As an optional feature, the x-axis component 1300′ may be adapted to mount different tools or heads (not shown), which may allow for mixing different materials in additive manufacturing or using different tools on the specimen in subtractive manufacturing. For instance, different mounts for heads may be provided sideways along the x-axis, along the y-axis or along the x-axis and y-axis (e.g., matrix of 4 tools). A rotating mechanism similar to the ones used on a microscope may also be used, allowing an active tool to be positioned at single location. The different heads may be, for instance, different hot end(s), pump(s) (ink, conductive ink, etc.), mill(s), laser(s), cutter(s), grinder(s), component positioner(s), etc.

In some embodiments, conductive ink may be printed on or, preferably, printed within one or more components of the set of parts 1000′ at the time of 3D printing. In such instances, the conductive ink may be used to replace one or more wires (e.g., for one or more of the motors 1800, limit-switches 1900, fans 2000, hot ends 2100 and/or other electric or electronic parts).

Some embodiments of the present invention are directed to a three-dimensional (3D) printer for 3D-printing a specimen therewithin, whether or not provided from a set of parts or as a complete apparatus. The 3D printer in accordance with such embodiments comprises a hot end similar to 2100, a controller (not shown) and a main structure 1102). The controller sets a definite 3D location of the hot end 2100 in relation to the specimen and controls the hot end 2100 for selectively extruding material to 3D-print the specimen. The main structure 1102 provides a first groove 2410′ defining a first plane along a z-axis within the 3D printer. The 3D printer also comprises a hot end holder (which may or may not be similar to the x-axis component 1300′), a specimen holder component similar to 1500′ and a z-axis motor assembly. The hot end holder 1300′ is provided on the main structure 1102 and moves the hot end 2100 along an x-axis within the 3D printer in accordance with instructions received from the controller, thereby determining an x-axis coordinate of the definite 3D location. The specimen holder component 1500′ is maintained in the first groove 2410′ of the main structure 1102. The specimen holder component 1500′ comprises a sliding plate 1520′ over which the specimen is 3D-printed by the hot end 2100 and a receiving surface 1506′ defining a second plane along a y-axis within the 3D printer. The first plane and the second plane are perpendicular. The specimen holder component 1500′ also comprises a y-axis motor 1503 assembly that causes the sliding plate 1520′ to slide on the receiving surface 1506′ in accordance with instructions received from the controller, thereby determining a y-axis coordinate of the definite 3D location. The receiving surface 1506′ may be defined strictly by the specimen holder component 1500′. The z-axis motor 1313 assembly is provided on the main structure 1102 and causes the specimen holder component 1500′, together with the y-axis motor 1503 assembly, to slide in the first groove 2410′ along the first plane in accordance with instructions received from the controller, thereby determining a z-axis coordinate of the definite 3D location. In some embodiments, the first plane and second plane may intersect along an edge of the specimen holder component 1500′ in the x-axis.

The sliding plate 1520′ is made of the single material and may comprise a removable receiver tray positioned of the sliding plate 1520′. The removable receiver tray or the sliding plate 1520′ may further comprise a specimen receiving plate, the specimen being printed thereon.

In some embodiments, the y-axis motor assembly may comprise ay-axis rack and pinion mechanism 1522′/1320′. The y-axis rack 1522′ thereof is integrated in the sliding plate 1520′ of the specimen holder component 1500′. The y-axis motor assembly may also comprise a y-axis motor 1800-4, fixably maintained under the specimen holder component 1500′ in a part 1504′ made of the single material, for controllably rotating the y-axis pinion 1320′ of the y-axis rack and pinion mechanism in accordance with instructions received from the controller.

In some embodiments, the z-axis-motor assembly may comprise a z-axis rack and pinion mechanism 1502′/1540′. The z-axis rack 1502′ being a part made of the single material and thereof integrated in the specimen holder component 1500 upon assembly. The z-axis-motor assembly may also comprise a z-axis motor 1800-2, fixably maintained on the main structure 1102 in a part 1260′ made of the single material, for controllably rotating the z-axis pinion of the z-axis rack and pinion mechanism in accordance with instructions received from the controller.

In some embodiments, the hot end holder comprises an x-axis-motor assembly comprising an x-axis rack and pinion mechanism 131071320′. The x-axis rack 1310′ thereof is slidably engaged in the groove 1242′ of the main structure 1102 along the x-axis and is solidarized with the hot end 2100. The x-axis-motor assembly may also comprise an x-axis motor 1800-3, fixably maintained on the main structure 1102 in the part 1400′ made of the single material, for controllably rotating the x-axis pinion 1320′ of the x-axis rack and pinion mechanism in accordance with instructions received from the controller.

In some embodiments, the 3D printer may further comprise an x-axis limit-switch 1900-1 for the hot end holder, a y-axis limit-switch 1900-2 for the specimen holder component 1500′ and a z-axis limit-switch 1900-3 for the z-axis component. The limit-switches may be similar to 1900 and used for calibrating the definite 3D location within the 3D printer.

In some embodiments, the 3D printer may further comprise a specimen holder adjustment tab 2400′ (see FIG. 22) made of the single material and assembled in parallel to the first plane to impede non-z-axis-movements of the specimen holder component 1500′ in the first groove 2410′.

Embodiments where structural elements of the 3D printer are provided as a modular construction set (e.g., interconnectable blocks) with provided parts made of the single material being compatible with the modular construction set. In some examples, the interconnectable blocks are limited to the usual ones that can easily be found from multiple providers (e.g., blocks of 2×2 and 2×4 and plates of 6×8). Elements from FIG. 4 may be used as is or modified to be made compatible with the technology from FIGS. 1-4 and 6-23. For instance, elements 1305, 1310, 1320, 1400, 1410, 1510, 1520, 1530. 1540, 1550, 1700, 1800, 1900, 2000, 2100 may be used as such or modified to be made compatible with the structural parts made from the modular construction set. More specifically, 1300′ is adapted from 1300; 1502′ is adapted from sub-element 1502; 1220′\1400′ is adapted from elements 1220 and 1400; 1270′\1272′ is adapted from elements 1270 and 1272; 1540′ is adapted from 1540; element 1320′ is adapted from 1320; 1260′ is adapted from sub-element 1260; 1504′ is adapted from sub-element 1504; 2400′ answers the same function as element 2400; 1410′ is adapted from 1410; element 1510′\1520′ is adapted from elements 1510 and 1520; 1530′ is adapted from 1530; 1330′ is adapted from 1330; and 1550′ is adapted from 1550.

The description of the present invention has been presented for purposes of illustration but is not intended to be exhaustive or limited to the disclosed embodiments. The different views are not necessarily drawn to scale. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A set of parts for assembling a three-dimensional (3D) printer for 3D printing a specimen therewithin, the 3D printer comprising a controller receiving instructions, when the 3D printer assembled from the set of parts is in use, for changing a definite 3D location of a hot end in relation to a specimen and for selectively extruding material from the hot end to print the specimen, the set of parts comprising:
one or more modular constructions sets comprising a plurality of interconnectable blocks for assembling structural elements of the 3D printer;
a hot end holder component for holding the hot end at the definite 3D location within the 3D printer when the set of parts is assembled into the 3D printer;
a specimen holder component for receiving the specimen within the 3D printer, the specimen holder component comprising a y-axis rack and pinion mechanism for moving a sliding plate component along a y-axis thereby determining a y-axis coordinate of the definite 3D location, a y-axis rack section of the y-axis rack and pinion mechanism being provided in a single material, the specimen holder component's structural elements being configured to be assembled from the plurality of interconnectable blocks;
an x-axis component comprising the hot end holder and comprising an x-axis rack and pinion mechanism for moving the hot end holder component along an x-axis therealong over the specimen holder component thereby determining an x-axis coordinate of the definite 3D location, an x-axis rack section of the x-axis rack and pinion mechanism being provided in the single material, the x-axis component's structural elements being configured provided in the single material; and
a z-axis component for moving the specimen holder component along a z-axis therealong thereby determining a z-axis coordinate of the definite 3D location when the set of parts is assembled into the 3D printer, the z-axis component's structural elements being configured to be assembled from the plurality of interconnectable blocks.

2. The set of parts of claim 1, wherein an x-axis pinion section of the x-axis rack and pinion mechanism, a y-axis pinion section of the y-axis rack and pinion mechanism and a z-axis pinion section of the x-axis rack and pinion mechanism are provided in the single material thereby providing the rack and pinions mechanisms along the x-axis, the y-axis and the z-axis in the single material.

3. The set of parts of claim 1, further comprising:
the controller;
an x-axis motor to be assembled in direct connection with the x-axis pinion section of the x-axis rack and pinion mechanism for moving the hot end component along the x-axis within the 3D printer; and
a y-axis motor to be assembled in direct connection with the y-axis pinion section of the y-axis rack and pinion mechanism for moving the specimen holder component along the y-axis within the 3D printer.

4. The set of parts of claim 1, further comprising:
an x-axis limit-switch for the x-axis component;
a y-axis limit-switch for the specimen holder component; and
a z-axis limit-switch for the z-axis component, the x-axis limit-switch, the y-axis limit-switch and the z-axis limit-switch being for calibrating the definite 3D location within the 3D printer when the 3D printer assembled from the set of parts is in use.

5. The set of parts of claim 1, wherein the sliding plate component's structural elements is configured to be assembled from the plurality of interconnectable blocks.

6. The set of parts of claim 1, wherein the plurality of interconnectable blocks consists of usual interconnectable blocks.

7. A three-dimensional (3D) printer for 3D-printing a specimen therewithin comprising:
a hot end;
a controller that:
sets a definite 3D location of the hot end in relation to the specimen; and
controls the hot end for selectively extruding material to 3D-print the specimen;
a support structure with a first groove defining a first plane along a z-axis within the 3D printer, the support structure being assembled from one or more modular construction sets comprising a plurality interconnectable blocks;
a hot end holder on the structure that moves the hot end along an x-axis within the 3D printer in accordance with instructions received from the controller, thereby determining an x-axis coordinate of the definite 3D location;
a specimen holder component assembled from the plurality of interconnectable blocks, maintained in the first groove of the enclosure, comprising:
a sliding plate over which the specimen is 3D-printed by the hot end;
a receiving surface defining a second plane along a y-axis within the 3D printer, the first plane and the second plane being perpendicular; and
a y-axis motor assembly that causes the sliding plate to slide in on the receiving surface in accordance with instructions received from the controller, thereby determining a y-axis coordinate of the definite 3D location; and
a z-axis motor assembly on the support structure that causes the specimen holder component comprising the z-axis motor assembly to slide in the first groove along the first plane in accordance with instructions received from the controller, thereby determining a z-axis coordinate of the definite 3D location.

8. The 3D printer of claim 7, wherein the sliding plate is assembled from the plurality of interconnectable blocks.

9. The 3D printer of claim 7, further comprising:
an x-axis limit-switch for the hot end holder;
a y-axis limit-switch for the specimen holder component; and
a z-axis limit-switch for the z-axis component, the x-axis limit-switch, the y-axis limit-switch and the z-axis limit-switch being for calibrating the definite 3D location within the 3D printer.

10. The 3D printer of claim 7, further comprising an adjustment tab parallel to the first plane to impede non-z-axis-movements of the specimen holder component in the first groove.

11. The 3D printer of claim 7, wherein the structure further provides an x-groove receiving the hot end holder.

12. The 3D printer of claim 7, wherein the plurality of interconnectable blocks consists of usual interconnectable blocks.
